(19) United States
(12) Patent Application Publication
(10) Pub. No.: US 2010/0282862 A1
(43) Pub. Date: Nov. 11, 2010

(54) PRESSURE WASHER WITH THROTTLE CONTROL

(75) Inventor: Richard J. Gilpatrick, Whitewater, WI (US)

Correspondence Address: Foley & Lardner LLP, 777 East Wisconsin Avenue, Milwaukee, WI, 53202-5306, US

(73) Assignee: Briggs & Stratton Corporation

(21) Appl. No.: 12/436,656

(22) Filed: May 6, 2009

(51) Int. Cl. B08B 3/02

(52) U.S. Cl. 239/88; 417/307

(57) ABSTRACT

A pressure washer includes a frame and an engine coupled to the frame. The engine has a throttle configured to control the speed of the engine. The pressure washer also includes a pump attached to the frame. The pump includes a housing with an inlet and an outlet formed in the housing. A flow path extends between the inlet and the outlet. The pump has a through mode, permitting water to flow through the flow path. And, the pump has a bypass mode establishing a recirculation circuit. The pressure washer also includes a pressure-sensitive member positioned along the flow path and attached directly to the recirculation circuit when the pump is in the bypass mode. The pressure-sensitive member has a first response to a water pressure occurring during the bypass mode and a second response to a water pressure occurring during the through mode. The pressure washer further includes a line of communication between the pressure-sensitive member and the throttle. When the pressure-sensitive member has the first response, the throttle sets a first engine speed, and when the pressure-sensitive member has the second response, the throttle sets a second engine speed.

### BACKGROUND

The present invention relates generally to the field of pressure washers. More specifically, the present invention relates to engine throttle controls for pressure washers having motorized pumps.

### SUMMARY

One embodiment of the invention relates to a pressure washer including a frame and an engine coupled to the frame. The engine has a throttle configured to control the speed of the engine. The pressure washer also includes a pump attached to the frame. The pump includes a housing with an inlet and an outlet formed in the housing. A flow path extends between the inlet and the outlet. The pump has a through mode, permitting water to flow through the flow path. And, the pump has a bypass mode establishing a recirculation circuit. The pressure washer also includes a pressure-sensitive member positioned along the flow path and attached directly to the recirculation circuit when the pump is in the bypass mode. The pressure-sensitive member has a first response to a water pressure occurring during the bypass mode and a second response to a water pressure occurring during the through mode. The pressure washer further includes a line of communication between the pressure-sensitive member and the throttle. When the pressure-sensitive member has the first response, the throttle sets a first engine speed, and when the pressure-sensitive member has the second response, the throttle sets a second engine speed.

Another embodiment of the invention relates to a motorized pump for a pressure washer system. The motorized pump includes an inlet structure designed to receive water from a source, such as a garden hose. The motorized pump also includes a pumping mechanism designed to drive the water through a chamber. In addition, the motorized pump includes an outlet structure designed to receive the water discharged from the chamber, and a recirculation line designed to recirculate the water from the outlet structure back to the inlet structure. The motorize pump further includes an unloader valve attached to the outlet. The unloader valve is designed to divert the water through the recirculation line in response to a high pressure condition in the outlet structure. The motorized pump also includes an engine speed control attached to the outlet structure, where the engine speed control includes a pressure sensor and a communication line attached to the pressure sensor. The pressure sensor is designed to communicate a water pressure sensed by the pressure sensor.

Yet another embodiment of the invention relates to pressure washer system that includes a frame, an engine coupled to the frame, and a throttle designed to control the speed of the engine. Additionally, the pressure washer system includes a pump attached to the frame, where the pump includes a manifold on an outlet side of the pump. The pressure washer system includes a spray gun coupled to the manifold. The spray gun includes an actuator having a first position permitting a water flow through the gun and a second position not permitting a water flow through the gun. The pressure washer system also includes a pressure-sensitive member directly attached to the outlet side of the pump. The pressure-sensitive member includes a pressure sensor. Also, the pressure-sensitive member has a first configuration responsive to a first water pressure and a second configuration responsive to a second water pressure, where the second water pressure is higher than the first water pressure. The pressure washer system further includes a communication line coupling the pressure-sensitive member and the throttle, where the pressure-sensitive member is in communication with the throttle. The throttle sets a first engine speed when the pressure-sensitive member is in the first configuration, and a second engine speed when the pressure-sensitive member is in the second configuration.

Alternative exemplary embodiments relate to other features and combinations of features as may be generally recited in the claims.

### BRIEF DESCRIPTION OF THE FIGURES

The present invention will become more fully understood from the following detailed description, taken in conjunction with the accompanying figures, wherein like reference numerals refer to like elements, in which:

FIG. 1 is a perspective view of a pressure washer system according to an exemplary embodiment.

FIG. 2 is a side perspective view of a water pump of the pressure washer system of FIG. 1.

FIG. 3 is a front perspective view of the water pump of FIG. 2.

FIG. 4 is a side perspective view of an engine of the pressure washer system of FIG. 1.

FIG. 5A is a sectional view of a trapped pressure unloader with an open main flow path according to an exemplary embodiment.

FIG. 5B is a sectional view of the trapped pressure unloader of FIG. 5A with an open bypass flow path and a closed main flow path.

FIG. 6A is a sectional view of a trapped pressure unloader with an open main flow path according to another exemplary embodiment.

FIG. 6B is a sectional view of the trapped pressure unloader of FIG. 6A with an open bypass flow path and a closed main flow path.

### DETAILED DESCRIPTION OF EXEMPLARY EMBODIMENTS

Before turning to the figures, which illustrate the exemplary embodiments in detail, it should be understood that the present invention is not limited to the details or methodology set forth in the description or illustrated in the figures. It should also be understood that the terminology is for the purpose of description only and should not be regarded as limiting.

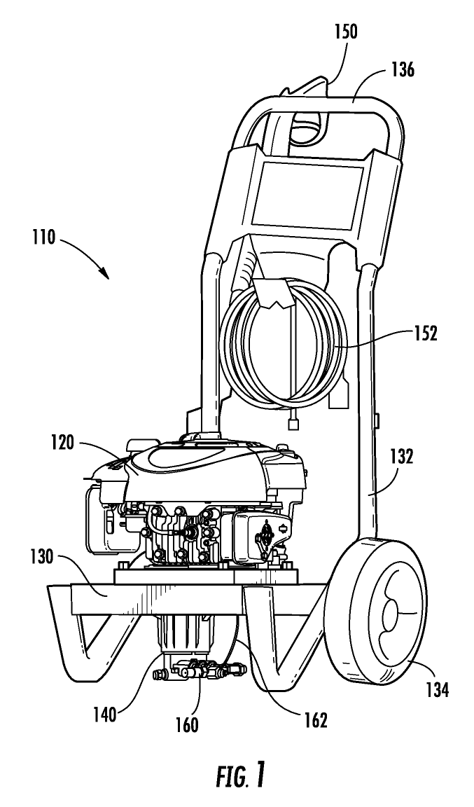

FIG. 1 shows a pressure washer system, according to an exemplary embodiment, in the form of a pressure washer system 110, including an engine 120, a frame 132, and a pump 140. The pressure washer system 110 also includes a spray gun 150 with a trigger actuator, where the spray gun 150 may be attached to the pump 140 by a high-pressure hose 152. The frame 132 includes a base plate 130, where the engine 120 and the pump 140 are coupled to the base plate 130. The support frame 132 also includes wheels 134 and a handle 136, such that a user can tilt the pressure washer system 110 about the wheels 134 and then roll the system 110 to a desired location for operation.

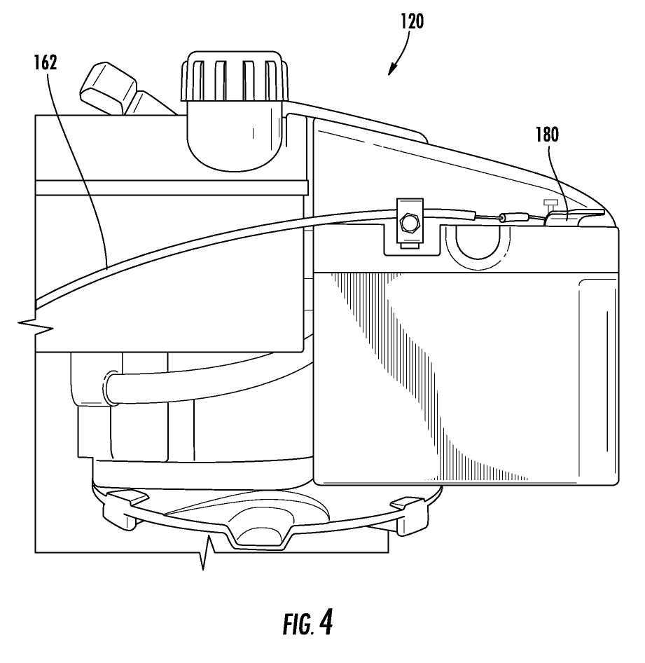

A pressure-sensitive member 160 is coupled to the pump 140. The pressure sensitive member 160 includes a pressure sensor that responds to a change in water pressure within the pump 140. Extending from the pressure sensitive member 160 is a communication line 162 that couples the pressure-sensitive member 160 to the engine 120. More specifically, the communication line 162 couples the pressure-sensitive member 160 to a throttle lever 180 (see FIG. 4) on the engine 120. Together the pressure-sensitive member 160 and the communication line 162 regulate the speed of the engine based upon water pressure in the pump 140.

According to the embodiment of FIG. 1, the engine 120 is fastened to a top side of the base plate 130 and the pump 140 is positioned on the underside of the base plate 130. In some embodiments, the pump 140 is attached directly to the engine 120. In still other embodiments, both the pump and the engine 120 are fastened on a same side of the base plate 130.

Still referring the FIG. 1, the engine 120 is an internal combustion engine having a four-stroke cycle, including intake, compression, combustion, and exhaust strokes. In other embodiments, the engine 120 may be a two-stroke combustion engine. In still other embodiments, the engine may be replaced by an electric motor, where instead of a throttle control, the pressure-sensitive member 160 and communication line 162 function to control the power supplied to the motor. Still other embodiments include other motors and engines.

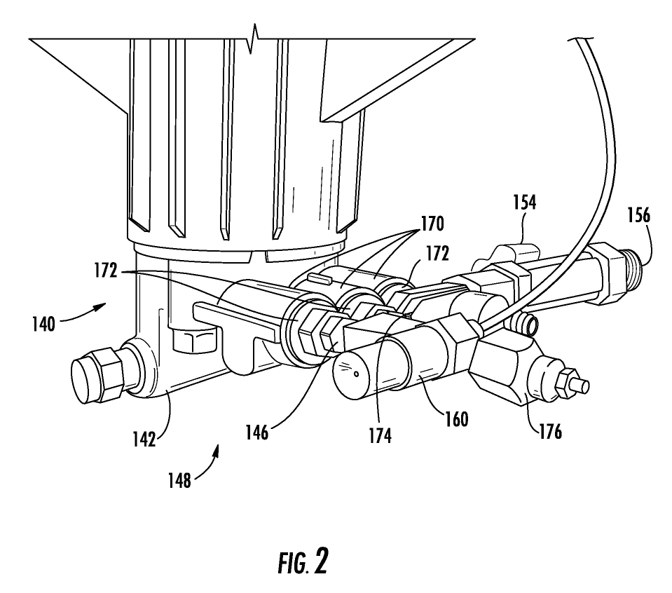

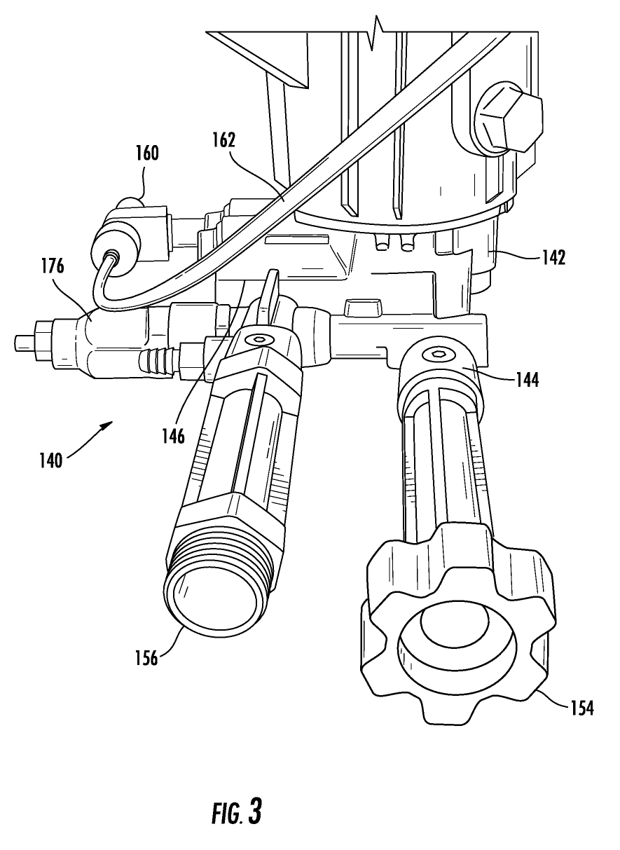

FIGS. 2 and 3 show perspective views of the water pump 140 of FIG. 1. The pump 140 has a housing 142 (e.g., a pump head) that can be divided into three main parts: an inlet structure 144, a pumping mechanism 148, and an outlet structure 146. A flow of water enters the inlet structure 144 through an inlet opening 154 with a coupling end, which may be a threaded female coupling, a female quick connect coupling, or some other form of coupling to attach a hose or pipe. From the inlet structure 144, the water is directed to the pumping mechanism 148. The pumping mechanism 148 pumps the inlet water to the outlet structure 146. The particular structure of the pumping mechanism 148 varies depending upon particular embodiments. For example, the pump 140 is shown as a positive displacement type pump having a chamber that isolates a body of water and then drives the water into the outlet structure 146. More specifically, the pump 140 is shown as an axial cam reciprocating pump having three pistons slidable within piston chambers 170. The pump pistons run on two-stroke cycles, with an inlet stroke and a discharge stroke. Following the pumping mechanism 148, the water enters the outlet structure 146, which includes a piston port 172 at the discharge end of the piston chamber 170, a discharge manifold 174 joining the water discharged from multiple piston ports 172, and a trapped pressure unloader 176 that is configured to divert flow into a bypass line when the spray gun 150 is not spraying.

In some embodiments, the pumping mechanism 148 includes one, two, three, or four pistons coupled to a power take-off member of the combustion engine 120. In other embodiments, the pumping mechanism 148 includes an axial cam that rotates to accelerate water injected near the center of the cam and ejected near the periphery of the cam. Still other embodiments include peristaltic pumps, scroll pumps, centrifugal pumps with spinning impellers, gear pumps, and other types of pumps with respective pumping mechanisms.

Still referring to FIGS. 2 and 3, the pressure-sensitive member 160 is shown coupled to the discharge manifold 174. Pressure sensitive members in other embodiments have any of a broad range of geometries, including a box shape, a cone shape, and or other shapes and combinations of shapes. In an exemplary embodiment, the pressure sensitive member 160 includes a biased plunger or piston that slides (linearly translates) within the cylinder as a function of pressure sensed.

In other embodiments, the pressure sensitive member 160 is formed from other mechanical components, such as a diaphragm coupled to a rod, where the rod converts the diaphragm position into a linear movement. Still other embodiments employ electrical sensors in the pressure-sensitive member 160, such as piezo-electric crystals that generate an electric signal proportional to pressure. In at least one embodiment, the pressure-sensitive member 160 is part mechanical and part electrical, including a biased sliding plunger with a magnet on the plunger, where the plunger is coupled to a Reed switch (e.g., a small, glass tube having a field-sensitive electric switch). A change in pressure causes the plunger to move the magnet relative to the Reed switch, which generates an electric signal as a function of pressure.

In other embodiments, characteristics other than water pressure are sensed, such as water flow rate, water turbulence, flow direction, and other characteristics. The characteristics may be sensed directly, such as with a sensor engaged with the flow. The characteristics may be sensed indirectly by coupling sensors to the structure of the pump 140, for example. In one embodiment, a strain gage is coupled to the outside of the discharge manifold 174, where the strain gage detects a change in pressure inside the discharge manifold 174 by sensing strain in the manifold 174 structure. The strain gage then converts a strain measurement into an electric signal proportional to the characteristic measured. Other sensors, such as vibrometers and accelerometers, may also be employed.

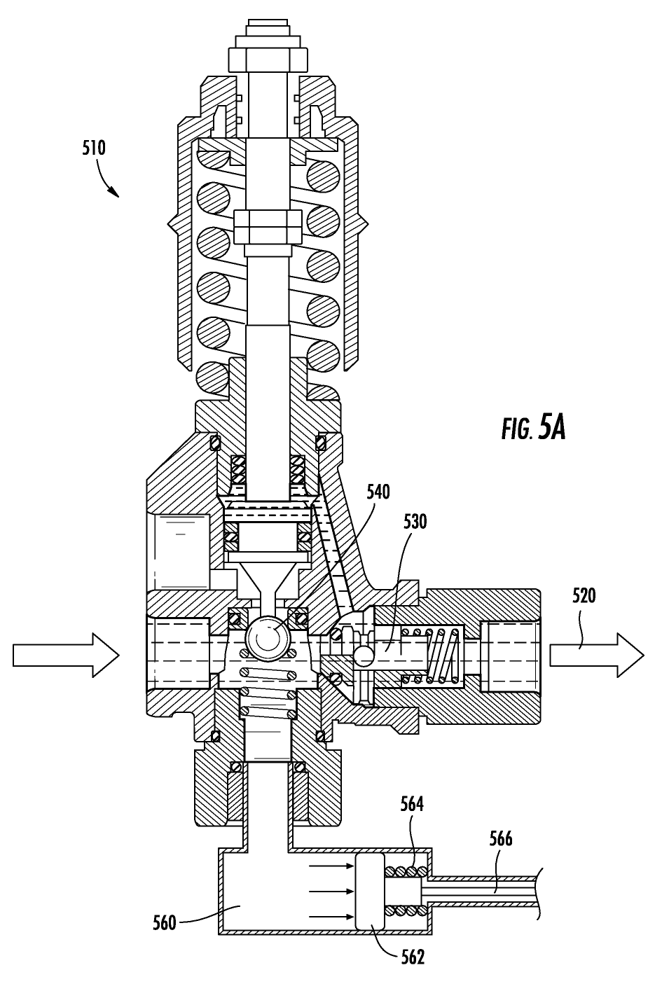

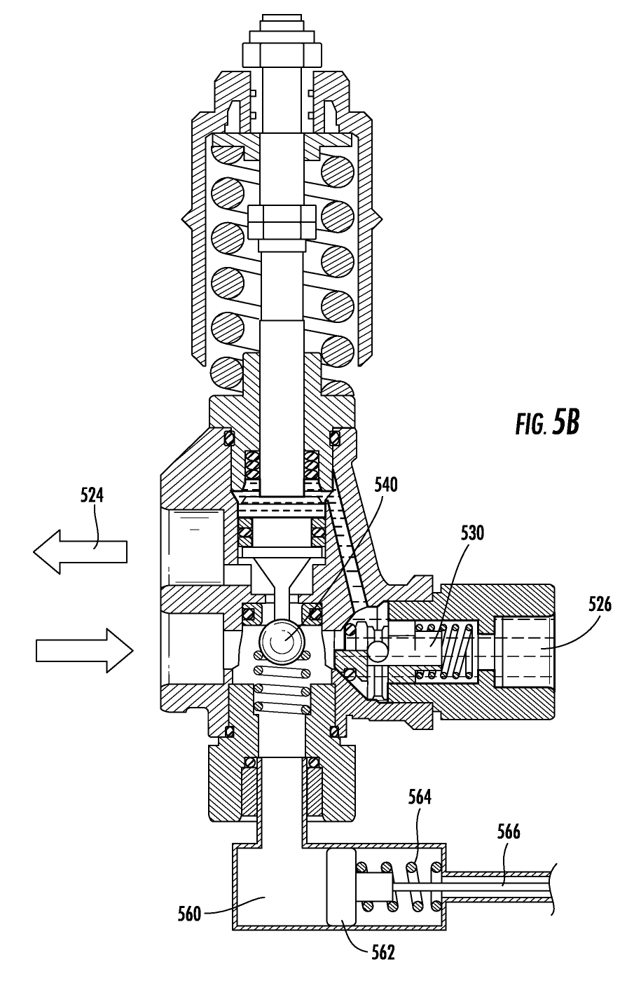

Still referring to FIGS. 2 and 3, the pressure-sensitive member 160 is attached to the pump 140 in a location where the pressure-sensitive member 160 is able to sense water pressure in the bypass line when the bypass line is active. More specifically the pressure-sensitive member 160 is attached to the discharge manifold 174 of the pump 140. In other embodiments, the pressure sensitive member is attached directly to the unloader 176, on the bypass line side of a check valve within the unloader 176 (see also FIG. 5A and 5B and the related disclosure). In still other embodiments, the pressure sensitive member 160 is attached to a piston port 172, or other portion of the pump outlet structure 146.

Positioning the pressure-sensitive member to be able to sense the water pressure in the bypass line when the bypass line is active provides a wide pressure differential between pressures experienced when the spray gun 150 (or other device, such as a sprinkler) is spraying (i.e., during a through mode) versus pressures experienced when the spray gun 150 is not spraying, but the motorized pump 140 is still running (i.e., during a bypass mode). For example, pressures experienced during the through mode may be greater than 1500 psi, such as 2500 psi. Pressures experienced during the bypass mode within the bypass line may be below 500 psi, such as 200 psi to 300 psi. As such, the pressure differential experienced by the pressure-sensitive member 160 between the through mode and the bypass mode, may exceed 1000 psi and as high as 2000 psi or more.

Referring now to FIGS. 2-4, the pressure-sensitive member 160 is attached to the communication line, shown as cable 162, which transmits a signal representative of a pressure sensed by the pressure sensitive member 160. The signal may be a direct result of the change in pressure, such as a mechanical movement, or may be an indirect signal, such as an electrical signal that is a function of the pressure, or other characteristic. In one embodiment, the cable is a Bowden cable. In other embodiments, the communication line may be a wire relaying an electric signal. In some embodiments the communication line may be replaced with a wireless signal, such as a radio frequency signal, transmitted from a transmitter coupled to the pressure-sensitive member 160 to a receiver located on the engine 120.

As shown in FIG. 4, the cable 162 directs the signal from the pressure-sensitive member 160 to the engine 120. More specifically, the signal is directed to a throttle control, shown as throttle lever 180, on the engine 120. Movement of the throttle lever 180 by the cable 162 adjusts the engine 120 speed as a function of pressure experienced by the pressure sensitive member 160. In other embodiments, such as embodiments employing an electrical signal, the signal is transmitted to a solenoid coupled to the throttle lever 180, which converts the signal to adjust the throttle lever 180.

The combination of the pressure-sensitive member 160, the communication line 162, and the connection to the throttle lever 180, together function as an engine speed control. The engine speed control has at least two control speeds, idle and a governed speed greater than the idle speed. In some embodiments, the engine speed control also includes an intermediate computer that receives signals from the communication line 162, converts the signals into engine 120 throttle control instructions. For example, in some embodiments, the computer provides an instruction to include a time delay between sensing a pressure and either idling or increasing the speed of the engine 120.

Still referring to FIG. 4 the throttle lever 180 is in the form of a lever coupled to a throttle plate. To increase engine speed, the throttle plate may be adjusted by the throttle lever 180 to allow for an increase in the air flow rate through a carburetor, where fuel is injected into the air flow.

FIGS. 5A and 5B show sectional views of a trapped pressure unloader 510 according to an exemplary embodiment. The pressure unloader 510 includes a biased check valve 530, a main flow path 520 through the unloader 510 (see FIG. 5A), a bypass line 524 flow path (see FIG. 5B), a ball valve 540, and a pressure-sensitive member 560. The unloader 510 is positioned adjacent to a pump discharge manifold in a pump outlet structure. The unloader 510 functions as a flow diverting valve designed to close one flow circuit, water flowing from the pump to the spray gun; and open another flow circuit, a recirculation within the pump directing water from the pump outlet back to the pump inlet.

When the check valve 530 is open, the unloader 510 is in the through mode, allowing water to flow along the main flow path 520 shown in FIG. 5A by arrows. When flow is restricted, the check valve 530 is closed, the unloader 510 is in a bypass mode. In the bypass mode, water within the unloader 510 is divided into an open bypass line 524 (shown in FIG. 5B with arrows) and a trap line 526. Pressure in the trap line 526 is directed above the ball valve 540 to open the ball valve 540 to engage the bypass line 524. The pressure-sensitive member 560 is attached to the unloader 510 on the bypass line 524 side of the check valve 530.

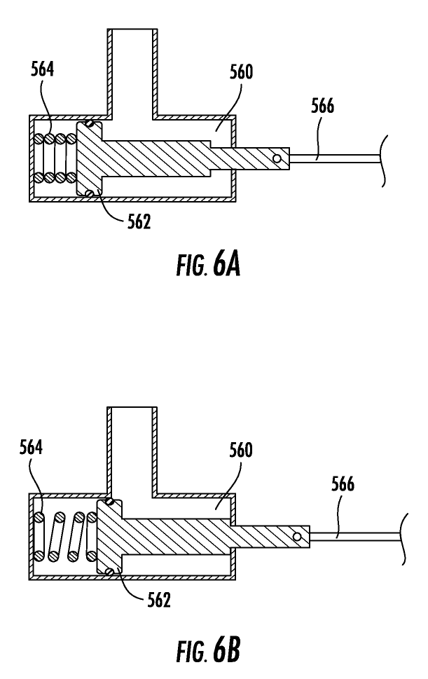

The pressure-sensitive member 560 is shown according to an exemplary embodiment, where the pressure-sensitive member 560 includes a plunger 562, the plunger 562 biased by a coil spring 564, and a Bowden cable wire 566 coupled to the plunger. FIG. 5A shows the pressure-sensitive member 560 in a first orientation in reaction to a high pressure. FIG. 5B shows the pressure-sensitive member 560 in a second orientation in reaction to a lower pressure. The Bowden cable wire 566 transmits the pressure-sensitive member orientation to a throttle of an engine driving the pump, such that the engine is set to an idle when the pressure-sensitive member 560 is in the second orientation, and the engine is set to a normal operational speed exceeding the idle speed when the pressure-sensitive member 560 is in the first orientation. FIGS. 6A and 6B show another configuration of a mechanical pressure sensitive member 560.

The construction and arrangement of the pressure washer and motorized pump, as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. A pressure washer, comprising:
a frame;
an engine coupled to the frame, the engine having a throttle configured to control the speed of the engine;
a pump coupled to the frame, the pump comprising a housing with an inlet and an outlet formed therein, wherein a flow path extends between the inlet and the outlet, the pump having a through mode permitting water to flow through the flow path and a bypass mode establishing a recirculation circuit;
a pressure-sensitive member positioned along the flow path and attached directly to the recirculation circuit when the pump is in the bypass mode, the pressure-sensitive member having a first response to a water pressure occurring during the bypass mode and a second response to a water pressure occurring during the through mode;
a line of communication coupling the pressure-sensitive member and the throttle, wherein when the pressure-sensitive member has the first response, the throttle sets a first engine speed, and when the pressure-sensitive member has the second response, the throttle sets a second engine speed.

2. The pressure washer of claim 1, wherein the first engine speed is an idle speed and the second engine speed is a governed speed greater than the idle speed.

3. The pressure washer of claim 2, wherein the pump housing comprises a discharge manifold and the pressure-sensitive member is coupled to the manifold.

4. The pressure washer of claim 3, further comprising an unloader valve adjacent to the manifold, the unloader valve configured to recirculate the water flow from the manifold to the pump inlet when a trap line pressure exceeds a threshold.

5. The pressure washer of claim 4, further comprising a spray gun coupled to the outlet, the spray gun comprising a trigger having a first position permitting a water flow through the gun and a second position not permitting a water flow through the gun.

6. The pressure washer of claim 5, wherein the pump is a positive displacement pump.

7. The pressure washer of claim 6, wherein the pump is a reciprocating pump.

8. The pressure washer of claim 5, wherein the threshold level is achieved when the trigger is in the second position.

9. A motorized pump for a pressure washer system, comprising:
an inlet structure configured to receive water from a source;
a pumping mechanism configured to drive the water through a chamber;
an outlet structure configured to receive the water discharged from the chamber;
a recirculation line configured to recirculate the water from the outlet structure back to the inlet structure;
an unloader valve coupled to the outlet, the unloader valve configured to divert the water through the recirculation line in response to a high pressure condition in the outlet structure;
an engine speed control attached to the outlet structure, the engine speed control comprising a pressure sensor and a communication line attached to the pressure sensor, the pressure sensor configured to communicate a water pressure sensed by the pressure sensor.

10. The motorized pump of claim 9, wherein the communication line is a mechanical linkage.

11. The motorized pump of claim 10, wherein in the communication line is a Bowden cable.

12. The motorized pump of claim 10, wherein the pumping mechanism comprises a piston slidable within the chamber.

13. The motorized pump of claim 9, wherein the outlet structure comprises a discharge manifold, and wherein the engine speed control is directly attached to the outlet structure.

14. A pressure washer system, comprising:
a frame;
an engine coupled to the frame;
a throttle configured to control the speed of the engine;
a pump coupled to the frame, the pump comprising a manifold on an outlet side of the pump;
a spray gun coupled to the manifold, the spray gun comprising an actuator having a first position permitting a water flow through the gun and a second position not permitting a water flow through the gun;
a pressure-sensitive member directly attached to the outlet side of the pump, the pressure-sensitive member comprising a pressure sensor, the pressure-sensitive member having a first configuration responsive to a first water pressure and a second configuration responsive to a second water pressure, the second water pressure higher than the first water pressure; and
a communication line coupling the pressure-sensitive member and the throttle;
wherein the pressure-sensitive member is in communication with the throttle, wherein the throttle sets a first engine speed when the pressure-sensitive member is in the first configuration, and the throttle sets a second engine speed when the pressure-sensitive member is in the second configuration.

15. The pressure washer system of claim 14, wherein the communication line provides for an electrical communication.

16. The pressure washer system of claim 15, wherein the communication line further comprises a solenoid coupled to the throttle.

17. The pressure washer system of claim 14, wherein the communication line comprises a mechanical connection between the engine speed control and the throttle.

18. The pressure washer system of claim 17, wherein the mechanical connection comprises a Bowden cable.

19. The pressure washer system of claim 18, wherein the first engine speed is an idle speed and the second engine speed is a governed speed greater than the idle speed.

20. The pressure washer system of claim 19, wherein the pump is a reciprocating pump.
